(19) United States
(12) Patent Application Publication
(10) Pub. No.: US 2013/0102261 A1
(43) Pub. Date: Apr. 25, 2013

(54) METHOD FOR CALIBRATING A BAND REJECTION FILTER OF A TERMINAL AND MULTISTANDARD TERMINAL WITH CALIBRATED BAND REJECTION FILTER

(71) Applicants: Jean-Yves Le Naour, Pace (FR); Dominique Lo Hine Tong, Rennes (FR); Ali Louzir, Rennes (FR); Raafat Lababidi, Tripoli (LB)

(72) Inventors: Jean-Yves Le Naour, Pace (FR); Dominique Lo Hine Tong, Rennes (FR); Ali Louzir, Rennes (FR); Raafat Lababidi, Tripoli (LB)

(73) Assignee: THOMSON LICENSING, Issy-les-Moulineaux (FR)

(21) Appl. No.: 13/807,745

(22) PCT Filed: Jun. 10, 2011
(86) PCT No.: PCT/EP2011/059728

§ 371 Date: Dec. 31, 2012

(30) Foreign Application Priority Data
Jul. 1, 2010 (FR) 1055318

(51) Int. Cl. H04B 1/52

(52) U.S. Cl. CPC H04B 1/525
USPC 455/78

(57) ABSTRACT

The present invention relates to a multimedia mobile terminal capable of transmitting and receiving signals compliant with several standards in the UHF band. It comprises:
a receiver receiving a first signal compliant with a first standard in a first frequency band,
   a first transmitter capable of transmitting a second signal compliant with a second standard in a second frequency band different from the first frequency band and partially intersecting the first frequency band,
wherein,
between the receiver and the antenna, a calibrated band-rejection filter comprising at least one variable element enabling the selection of a rejection frequency by the control voltage of said variable element.
a filtering control element to store the control voltage values and the associated rejecting frequency values determined during a calibration procedure and to transmit according to the second frequency of the first transmitter the stored control voltage of said variable element of said band-rejection filter.

This application claims the benefit, under 35 U.S.C. §365 of International Application PCT/EP2011/059728, filed Jun. 10, 2011, which was published in accordance with PCT Article 21(2) on Jan. 5, 2012 under international publication number WO2012000777 in English and which claims the benefit of French patent application No. 1055318, filed Jul. 1, 2010.

### FIELD OF THE INVENTION

The present invention relates to a multimedia mobile terminal capable of transmitting and receiving signals compliant with several standards in the UHF band.

### BACKGROUND OF THE INVENTION

The growing number of multimedia services and standards used for the implementation of these services, such as the standards GSM (Global System for Mobile communications), WiFi (Wireless Fidelity), UMTS (Universal Mobile Telecommunications System), GPS (Global Positioning System), DVB-T (Digital Video Broadcasting—Terrestrial), DVB-H and WiMAX (Worldwide Interoperability for Microwave Access), makes the management of the radio frequency spectrum more and more difficult.

In this context, it was decided to assign to these services at least part of the resources of frequencies released by the switchover of television broadcasting from analogue mode to digital mode. The sub-band [790 MHz-862 MHz], commonly called digital dividend, has already been assigned for these service types. The programmed switchover to all-digital will also enable the local use, under certain conditions, of channels in the UHF band [470 MHz-790 MHz] for the broadcast of digital television but also for other applications and services. This band of frequencies, commonly called “white space” is the subject of great interest on the part of all actors in the domain of multimedia and telecommunications services. Moreover, this band of frequencies is particularly sought after by telecommunications operators, due to a superior level of efficiency with respect to frequencies higher than 1 GHz, in terms of coverage and penetration of buildings, and in terms of very much lower costs for the creation and operation of networks.

Access to these new frequencies will generate the development of user terminals, particularly mobile terminals, offering to users in mobile situations or at home a wide range of services (digital television, telephone, Internet, etc.). These multimedia terminals will integrate more and more new functions to respond, on one hand, to the multiplication of access networks, and, on the other hand, to the emergence of new applications and services, such as for example digital television on mobile terminals or home wireless networks.

In this context, one of the major issues is to enable the mobile terminal to transmit and receive simultaneously signals belonging to the same band of frequencies, particularly in the digital dividend or “white space”, and corresponding to different applications or services, without the reception being too degraded.

For example, in the case of a mobile terminal capable of receiving a DVB-H signal and accessing a WiMAX type mobile network and a GSM type mobile telecommunications network, said terminal must be capable when it accesses the WiMAX network and/or the GSM network, of receiving DVB-H signals although the frequency of WiMAX signals transmitted by the terminal is very close to the frequency of the DVB-H signal. In fact, in a standard operating mode, the transmission of signals to the WiMAX network can interfere with the DVB-H reception due to the physical proximity of antennas on the terminal and the significant coupling that results.

One purpose of the present invention is to propose a multi-standard multimedia mobile terminal enabling these problems of reception due to the proximity in frequencies of transmitted and received signals to be resolved.

### SUMMARY OF THE INVENTION

For this purpose, the present invention proposes a multi-standard multimedia mobile terminal comprising:
a receiver receiving a first signal compliant with a first standard in a first frequency band,
a first transmitter capable of transmitting a second signal compliant with a second standard in a second frequency band different from the first frequency band and partially intersecting the first frequency band,
   wherein
between the receiver and the antenna, a calibrated band-rejection filter comprising at least one variable element enabling the selection of a rejection frequency by the control voltage of said variable element.
a filtering control element to store the control voltage values and the associated rejecting frequency values determined during a calibration procedure and to transmit according to the second frequency of the first transmitter the stored control voltage of said variable element of said band-rejection filter.

Advantageously, the band-rejection filter comprises at least one variable element, for example a capacitor, to be able, despite the dispersions and the tolerances of components of the filter, to precisely adjust the rejection frequency of the filter onto the frequency of the second signal.

Advantageously, the terminal also comprises a first shunt to short-circuit said band-rejection filter when said first transmitter does not transmit a second signal or when the signal-to-noise ratio at the output of the receiver is greater than a threshold value.

Advantageously, the second frequency band is comprised between a third frequency and a fourth frequency, said fourth frequency being greater than aid third frequency and interfering with said first frequency band.

According to a particular embodiment, the terminal also comprises:
a second transmitter capable of transmitting a third signal compliant with a third standard in a third band of frequencies comprised between the frequencies f5 and f6, with f6>f5 and f5>f4 and f5>f2, and
a low-pass filter, upstream of the said receiver, in order to, when said second transmitter transmits a third signal, filter said third signal.

The function of this low-pass filter is to suppress, upstream of the receiver, the interfering signals for which the frequency is greater than f4.

According to a particular embodiment, a shunt circuit is also provided to short-circuit said low-pass filter when said second transmitter does not transmit a third signal.

According to a particular embodiment, said first band of frequencies and said second band of frequencies are comprised at least partially in the band [470 MHz-862 MHz] corresponding to the digital dividend and “white space”, or in the band [470 MHz-790 MHz].

According to a particular embodiment, the first standard is the DVB-H standard, the second standard is the WiMAX standard and/or the third standard is the GSM standard.

The invention also relates to a method for calibration of the band-rejection filter of the previously defined terminal. Said method comprises the following steps for:

E1) initializing a frequency fat the frequency f3;
E2) transmitting a second signal at the frequency f via said first transmitter;
E3) adjusting the receiving frequency of the receiver at the frequency f;
E4) varying the control voltage of said at least one variable element of the band-rejection filter so as to determine the control voltage of said at least one variable element enabling the amplitude of the baseband signal at the receiver output to be minimized;
E5) storing in a memory of the terminal the control voltage of said at least one variable element determined in step d);
E6) checking whether the frequency f is equal to the frequency f2, and
E7) incrementing the frequency f with a predetermined frequency step and repeating steps E2) to E6) until the frequency f is equal to f2.

Preferably, the power of the second signal transmitted during step b) is low, preferably in the order of −45 dBm in order not to interfere with the reception of other terminals present in the same area.

According to a particular embodiment, the method for calibration is carried out upon powering up of the mobile terminal and/or periodically.

### BRIEF DESCRIPTION OF THE DRAWINGS

The invention will be better understood, and other aims, details, characteristics and advantages will appear more clearly during the following detailed explanatory description by referring above to the annexed drawings, which represent:

FIG. 1, a diagram of frequency bands assigned for the standards DVB-H, WiMAX and GSM;

FIG. 2, a multi-standard mobile terminal capable of receiving DVB-H signals and of transmitting and receiving WiMAX and GSM signals;

FIG. 3, a diagram of said terminal of FIG. 2;

FIG. 4, a diagram of a band-rejection filter of the terminal of FIG. 3;

FIG. 5, a flow chart of the method for control of the terminal of the invention, and

FIG. 6, a flow chart of a method for calibration of the band-rejection filter of the terminal of the invention.

### DETAILED DESCRIPTION OF PREFERRED EMBODIMENTS

The invention will be described in the context of a multi-standard mobile terminal capable of receiving DVB-H signals, of transmitting and receiving WiMAX signals, and of transmitting and receiving GSM signals, the DVB-H signals and the WiMAX signals being comprised in the band of frequencies [470 MHz-862 MHz] of the digital dividend and of the “white space”.

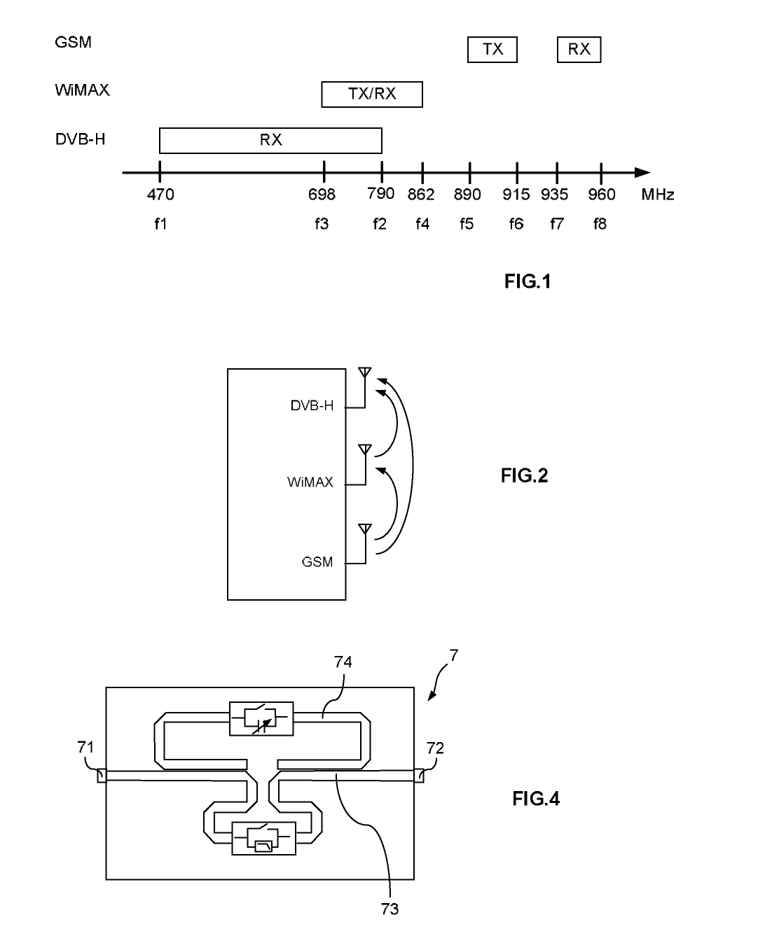

An example of frequency bands assigned to these standards is shown on FIG. 1. The DVB-H signals are contained in the band of frequencies extending between the frequency f1=470 MHz and the frequency f2=790 MHz. The WiMAX signals are contained in the band of frequencies extending between the frequency f3=698 MHz and the frequency f4=862 MHz. Finally, the GSM signals are contained in the band of frequencies extending between the frequency f5=890 MHz and the frequency f6=915 MHz for the transmission and the band of frequencies extending between the frequency f7=890 MHz and the frequency f8=915 MHz for the reception. Any transmission via the terminal in the band of frequencies [470 MHz-790 MHz] or in a close band can interfere with the reception of DVB-H signals.

As illustrated in FIG. 2, the transmission of WiMAX signals in the frequency band [698 MHz-790 MHz] can interfere with the reception of DVB-H signals just like the transmission of GSM signals in the frequency band [890 MHz-915 MHz] can interfere with the reception of DVB-H signals and WiMAX signals. Therefore, filtering means are provided upstream of the receiver to filter these interfering signals.

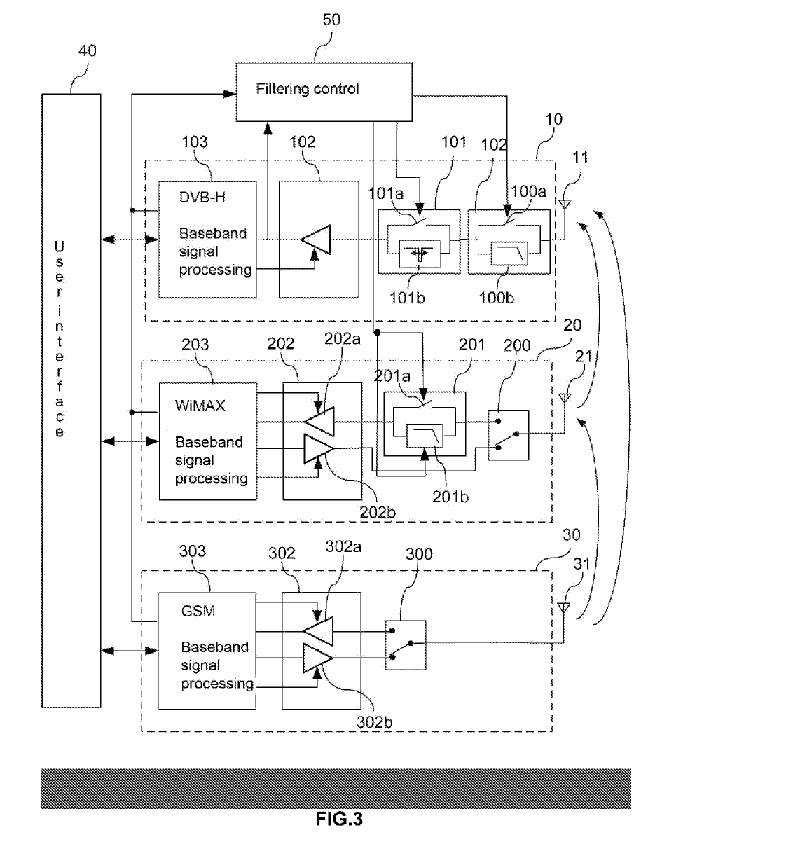

In reference to FIG. 3, the mobile terminal comprises first means 10 to receive and process the DVB-H signals, second means 20 to transmit, receive and process the WiMAX signals and third means 30 to transmit, receive and process the GSM signals.

The first means 10 are connected on the one hand to an antenna 11 and on the other hand to a user interface 40 of the terminal. The first means 10 comprise a receiver 102 the input of which is connected, via filtering means 100 and 101, to the antenna 11 and the output of which is connected to the input of a processing circuit 103. The output of the processing circuit 103 is connected to the user interface 40. The receiver 102 extracts from the signal coming from the filtering means 100 and 101 a baseband signal, which baseband signal is then processed by the processing circuit 103.

The filtering means 100 and 101 are cascaded upstream of the receiver 102. The function of the filtering means 100 is to filter, upstream of the receiver 102, the GSM signals transmitted via the terminal. They comprise a switch 100a connected in parallel with a low-pass filter 100b capable of filtering the GSM signals. The cut-off frequency of the low-pass filter 100b is equal to f5=890 MHz. The switch 100a is used to shunt the low-pass filter 100b when the terminal does not transmit GSM signals. It is closed when the terminal does not transmit GSM signals and open when the terminal transmits GSM signals.

The function of the filtering means 101 is to filter upstream of the receiver 102 the WiMAX signals if the reception of the DVB-H signals is poor, i.e. when the signal-to-noise ratio at the output of the receiver 102 is not high enough. The filtering means 101 comprise a switch 101a connected in parallel with a band-rejection filter 101b capable of filtering the WiMAX signals. The centre frequency of the band-rejection filter 101b is adjusted onto the WiMAX transmitting frequency. The switch 101a is used to shunt the band-rejection filter 101b when the terminal does not transmit WiMAX signals or when the signal-to-noise ratio at the output of receiver 102 is greater than a threshold value, for example 20 dB. It is closed when the terminal does not transmit WiMAX signals or when the signal-to-noise ratio at the output of the receiver 102 is greater than a threshold value and it is open in the other cases.

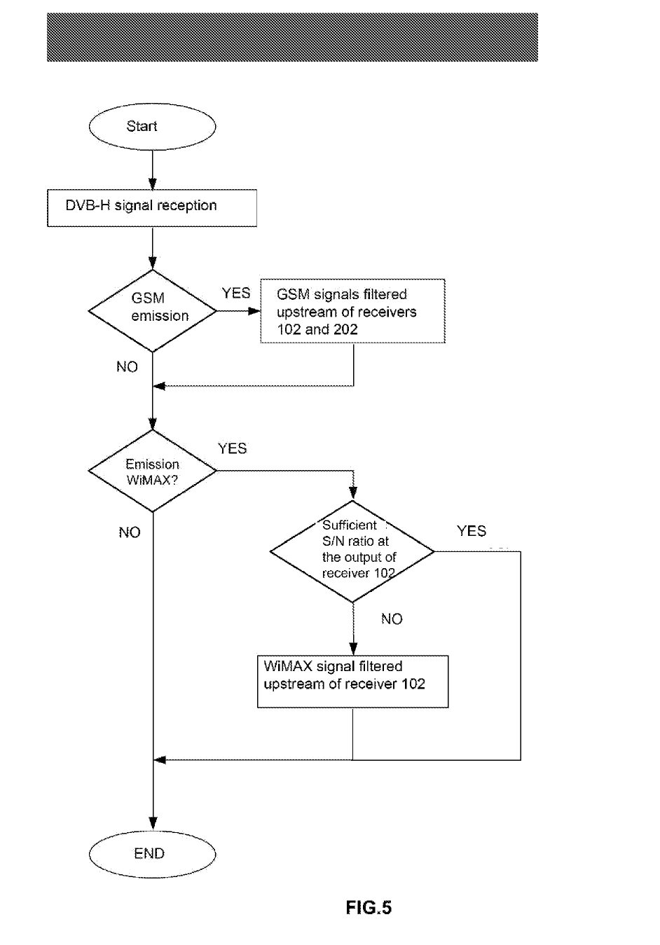

According to a particular embodiment, the filtering means 100 and 101 are integrated together. An example of integrated filter is shown in FIG. 4. The overall structure of this filter is described in the document called “Exact Synthesis of Microwave Filters with Nonuniform Dissipation”, of C. Guyette et al., IEEE IMS-2007.

This filter, referenced 7, comprises, between an input port 71 and an output terminal 72 of the filter, a first transmission channel, called direct channel 73, to which a second transmission channel, called secondary channel 74, is coupled. These two channels are materialized by micro-strip transmission lines, also called micro-strip lines.

The direct channel 73 comprises transmission line portions forming the low-pass filter 100b and the switch 100a.

The secondary channel 74 comprises transmission line portions forming the band-rejection filter 101a and the switch 101b. Said secondary channel forms a resonant element the resonant frequency of which corresponds to the frequency to be rejected. The band-rejection filter comprises at least one variable capacitor enabling the rejection frequency (or centre frequency) of the filter to be adjusted. The two switches for example are materialized by diodes.

The filter topology is defined in order that, at the resonant frequency of the secondary channel, the signal coming from the direct channel 73 and that coming from the secondary channel 74 combine in phase opposition at the filter output to create a theoretically infinite attenuation in a relatively narrow band around the resonant frequency.

By referring again to FIG. 3, the second means 20 relating to the WiMAX signals are connected on the one hand to an antenna 21 and on the other hand to the user interface 40. They comprise a transmitter-receiver 202 comprising more particularly a receiver 202a and a transmitter 202b.

The input of the receiver 202a is connected, via filtering means 201, to the antenna 21 and the output of the receiver 202a is connected to an input of a processing circuit 203. The receiver 202a extracts from the signal coming from the filtering means 201a baseband signal which is then processed by the processing circuit 203. The processing circuit 203 is moreover connected to the user interface 40.

The input of the transmitter 202b is connected to an output of the processing circuit 203 and the output of the transmitter 202b is connected to the antenna 21. A switch 200 is provided to selectively connect the antenna 21 to the input of the filtering means 201 or to the output of the transmitter 202b.

The function of the filtering means 201 is to filter upstream of the receiver 202a the GSM signals when the terminal transmits such signals. They comprise a switch 201a connected in parallel with a low-pass filter 201b capable of filtering the GSM signals. The cut-off frequency of the low-pass filter 201b is equal to f5=890 MHz. The switch 201a is used to shunt the low-pass filter 201b when the terminal does not transmit GSM signals. It is closed when the terminal does not transmit GSM signals and open when the terminal transmits GSM signals.

Finally, the third means 30 relating to the GSM signals are connected on the one hand to an antenna 31 and on the other hand to the user interface 40. They comprise a transmitter-receiver 302 comprising more particularly a receiver 302a and a transmitter 302b.

The input of the receiver 302a is connected to the antenna 31 and the output of the receiver 302a is connected to an input of a processing circuit 303. The receiver 302a extracts from the signal coming from the antenna 31 a baseband signal which is then processed by the processing circuit 303. The processing circuit 303 is moreover connected to the user interface 40.

The input of the transmitter 302b is connected to an output of the processing circuit 303 and the output of the transmitter 302b is connected to the antenna 31. A switch 300 is provided to selectively connect the antenna 31 to the input of the receiver 302a or to the output of the transmitter 302b.

The terminal also comprises a control circuit 50 intended to control the filtering means 100, 101 and 201. The control circuit 50 receives signals coming from the processing circuits 103, 203 and 303 as well as the baseband signal coming from the receiver 102. It determines the signal-to-noise ratio of the baseband signal coming from the receiver 102 and determines the command to be applied to the filtering means 101 according to this ratio.

The operating mode of the terminal is described in more detail in reference to FIG. 5.

When the receiver 102 (DVB-H) operates, the control circuit of the filters 50 checks whether the terminal transmits a GSM signal. If it transmits a GSM signal, it is filtered, upstream of the receivers 102 and 202, using the filters 100b and 201b. In the absence of GSM signal, the filters 100b and 201b are shunted by means of the switches 100a and 201a.

The control circuit of the filters 50 then checks on the one hand whether the terminal transmits a WiMAX signal and, on the other hand, whether the signal-to-noise ratio of the baseband signal at the output of the receiver 102 is sufficient (greater than the threshold value). If the terminal transmits a WiMAX signal, and if the signal-to-noise ratio is sufficient, upstream of the receiver 102, the WiMAX signal is filtered using the filter 101b. In the absence of WiMAX signal, the filter 101b is shunted by means of the switch 101a.

This operating phase is preferably preceded by a calibration phase of the band-rejection filter 101b. This calibration phase is intended to determine and store, for each frequency of the WiMAX signal comprised in the DVB-H frequency band, the control voltage of the variable element or variable elements of the filter enabling this frequency to be filtered. In the case of a band-rejection filter comprising a variable capacitor, this involves determining and storing the control voltage of this capacitor for each of the WiMAX signal frequencies comprised in the DVB-H frequency band.

The WiMAX signal frequencies comprised in the DVB-H frequency band are comprised in the frequency band [698 MHz-790 MHz], i.e. [f2, f3].

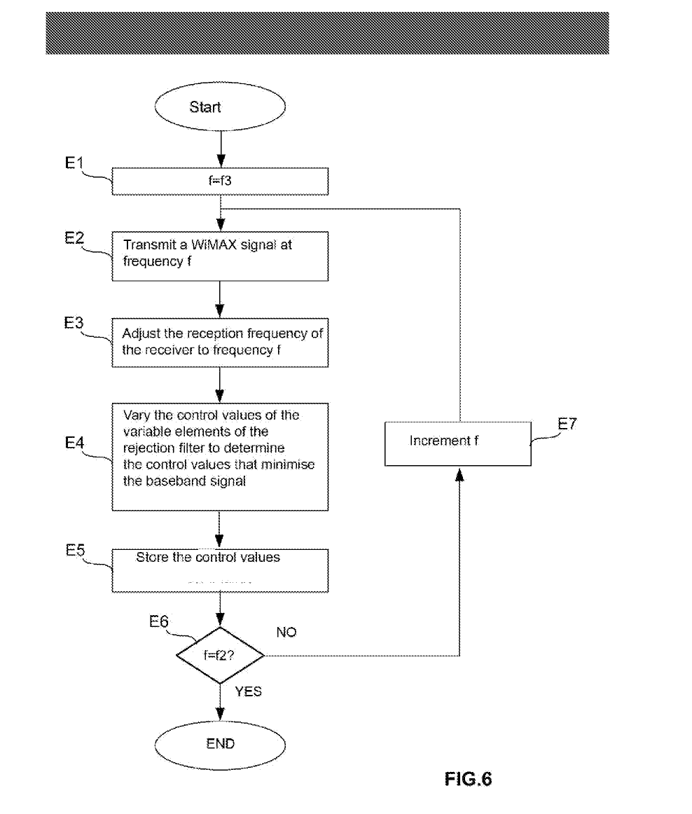

In reference to FIG. 6, this calibration phase comprises the following steps for:
step E1: initializing a frequency fat the frequency f3,
step E2: transmitting a WiMAX signal at the frequency f,
step E3: adjusting the receiving frequency of the receiver 102 at the frequency f and, possibly, adjusting the control voltage of the variable element or elements of the filter at a predefined value enabling the centre frequency of the band-rejection filter to be roughly adjusted at the frequency f,
step E4: varying the control voltage of the variable element or elements of the band-rejection filter, preferably around the predefined value, so as to determine the precise control voltage or voltages enabling the baseband signal amplitude at the output of the receiver 102 to be minimized; the measurement of the baseband signal amplitude at the output (I/Q output) of the receiver 102 is performed by a circuit internal or external to the control circuit 50,
step E5: storing the control voltage of the variable element or elements determined in step E5 in a memory of the control circuit 50,
step E6: checking whether the frequency f is equal to f2, and
step E7: incrementing the frequency f with a predetermined frequency step and recommencing steps E2 to E6 until the frequency f is equal to f2.

Owing to the significant coupling between the antennas of the terminal, particularly between the antennas 11 and 21, the transmission of the WiMAX signal during step E2 can be performed with a low transmitting level, this transmitting level being defined to be detectable by the receiver 102 while impeding as little as possible the reception of multimedia terminals placed in the vicinity of the present terminal.

For a receiver 102 (DVB-H) of sensitivity equal to −95 dBm with a signal-to-noise ratio of 10 dB, an average receiving level of 40 dB above the sensitivity threshold and an isolation between the antennas of 10 dB, the required power level is equal to −95+40+10=−45 dBm.

According to the invention and following this calibration phase, for each WiMAX signal transmitting frequency, the control circuit of the filters 50 emits a control voltage determined during this calibration phase which enables the variable elements of the filter to be dynamically selected to obtain the rejection frequency corresponding to the transmitting frequency of the WiMAX signal.

According to the invention, the control voltages determined during this calibration phase are all the more precise that all the local oscillators of the terminal transmitters and receivers depend on the same reference signal. So, during this calibration phase, the frequency of the local oscillator of the receiver 102 (DVB-H) is a multiple of or is equal to the frequency of the local oscillator of the transmitter 202b (WiMAX).

The calibration phase is performed upon the powering up of the terminal and/or periodically. Such a structure and such an operation of the terminal according to the invention enable the DVB-H reception to be dynamically optimized on the terminal according to the services requested by the user.

Naturally, the invention is not limited to DVB-H/WiMAX/GSM terminals. It applies to all types of terminals receiving and transmitting in the same frequency band signals of different standards. Although the invention has been described in relation to a specific embodiment, it is evident that this is in no way restricted and that it comprises all technical equivalents of the means described as well as their combinations if these fall within the scope of the invention.

1-8. (canceled)

9. A multi-standard multimedia mobile terminal comprising:
a receiver receiving a first signal compliant with a first standard in a first frequency band
a first transmitter capable of transmitting a second signal compliant with a second standard in a second frequency band different from the first frequency band and partially intersecting the first frequency band,
wherein,
between the receiver and the antenna, a calibrated band-rejection filter comprising at least one variable element enabling the selection of a rejection frequency by the control voltage of said variable element.
a filtering control element to store the control voltage values and the associated rejecting frequency values determined during a calibration procedure and to transmit according to the second frequency of the first transmitter the stored control voltage of said variable element of said band-rejection filter.

10. The multi-standard multimedia mobile terminal according to claim 9 wherein the band-rejection filter comprises at least one variable element to precisely adjust the rejection frequency of the filter onto the frequency of the second signal.

11. The multi-standard multimedia mobile terminal according to claim 10 wherein the variable element is a capacitor.

12. The multi-standard multimedia mobile terminal according to claim 9 wherein said second frequency band is comprised between a third frequency and a fourth frequency, said fourth frequency being greater than aid third frequency and interfering with said first frequency band.

13. The multi-standard multimedia mobile terminal according to claim 9, wherein it also comprises a first shunt to short-circuit said band rejection filter when said first transmitter does not transmit a second signal or when the signal-to-noise ratio of the signal at the receiver output is greater than a threshold value.

14. The multi-standard multimedia mobile terminal according to claim 9, wherein it also comprises:
a second transmitter capable of transmitting a third signal compliant with a third standard in a third band of frequencies comprised between two frequencies f5 and f6, with f6>f5 and f5>f4 and f5>f2, and
a low-pass filter, upstream of the said receiver, in order to, when said second transmitter transmits a third signal, filter said third signal.

15. The multi-standard multimedia mobile terminal according to claim 14, where a shunt circuit is also provided to short-circuit said low-pass filter when said second transmitter does not transmit a third signal.

16. The multi-standard multimedia mobile terminal according to claim 9, wherein the first standard is the DVB-H standard.

17. The multi-standard multimedia mobile terminal according to claim 9, wherein the second standard is the WiMAX standard and/or the third standard is the GSM standard.
